(19) United States
(12) Patent Application Publication
(10) Pub. No.: US 2017/0255684 A1
(43) Pub. Date: Sep. 7, 2017

(54) INFORMATION PROCESSING APPARATUS AND USER SEARCH METHOD

(71) Applicant: FUJITSU LIMITED, Kawasaki-shi (JP)

(72) Inventor: Hiroki Kunimura, Ota (JP)

(73) Assignee: FUJITSU LIMITED, Kawasaki-shi (JP)

(21) Appl. No.: 15/432,260

(22) Filed: Feb. 14, 2017

(30) Foreign Application Priority Data
Mar. 3, 2016 (JP) 2016-040710

(51) Int. Cl. G06F 17/30

(52) U.S. Cl. CPC G06F 17/30554; G06F 17/30528; G06F 17/30572; G06T 11/206

(57) ABSTRACT

An information processing apparatus includes a storage unit and a computing unit. The computing unit receives registration of information corresponding to a user and indicating levels of a plurality of skill items. Further, the computing unit receives an input specifying levels of the plurality of skill items, and displays a radar chart including a first graph based on the specified levels. The computing unit executes a search for a user from among users who are registered, using the specified levels as a search condition. The computing unit displays a radar chart including a second graph based on levels of the plurality of skill items corresponding to a user found by the search, in a manner associated with the found user.

### CROSS-REFERENCE TO RELATED APPLICATION

This application is based upon and claims the benefit of priority of the prior Japanese Patent Application No. 2016-040710, filed on Mar. 3, 2016, the entire contents of which are incorporated herein by reference.

### FIELD

The embodiments discussed herein are related to an information processing apparatus and a user search method.

### BACKGROUND

Information search techniques using an information processing apparatus have been widely used. As one such information search technique, for example, there has been disclosed a technique that searches for a person whose score pattern is close to that of a model person, based on the degree of correlation between the score patterns and the degree of concordance between the areas of the graphs representing the score patterns. There has also been disclosed a technique wherein an information provision and search apparatus presents to the user their preference information before the user searches for a television program. There has also been disclosed a technique wherein a Web server compares waveform data representing the price movement of a stock specified by the user with waveform data of individual stocks stored in a storage unit of the Web server, and finds an individual stock having waveform data close to that of the specified stock.

See, for example, Japanese Laid-open Patent Publications No. 2014-119394, No. 2004-355429, and No. 2008-262519.

It is sometimes needed to search for a user having a certain skill. For example, the organizer of a business event needs to search for people whose participation in the event is desired. When a search is executed, the search result is displayed on an information processing apparatus. However, if the information processing apparatus displays only the search result, it is difficult for the searcher to determine how well the found user matches the search condition.

### SUMMARY

According to one aspect, there is provided an information processing apparatus including: a memory; and a processor configured to perform a process including: receiving registration of information corresponding to a user and indicating levels of a plurality of skill items, and registering the information in the memory, receiving an input specifying levels of the plurality of skill items, and displaying a radar chart including a first graph based on the specified levels, executing a search for a user from among users who are registered, using the specified levels as a search condition, and displaying a radar chart including a second graph based on levels of the plurality of skill items corresponding to a user found by the search, in a manner associated with the found user.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates an information processing system according to a second embodiment;

FIG. 3 illustrates an example of hardware of a management server;

FIG. 4 illustrates an example of functions of the management server;

FIG. 5 illustrates an example of a user table;

FIG. 6 illustrates an example of a workshop object table;

FIG. 7 illustrates an example of a workshop participation table;

FIG. 8 illustrates an example of a workshop invitation table.;

FIG. 9 illustrates an example of a recommendation table;

FIG. 10 illustrates an example of a user information registration screen;

FIG. 11 is a flowchart illustrating an example of a process of registering user information;

FIG. 12 illustrates an example of a user information screen and a workshop information registration screen;

FIG. 13 is a flowchart illustrating an example of a process of registering workshop information;

FIG. 14 illustrates an example of a user search screen;

FIG. 15 illustrates an example of a user search result screen;

FIG. 16 is a flowchart illustrating an example of a user search process;

FIG. 17 illustrates an example of a workshop invitation screen;

FIG. 18 is a flowchart illustrating an example of a workshop invitation process;

FIG. 19 illustrates an example of a workshop list screen and an application screen;

FIG. 20 is a flowchart illustrating an application process;

FIG. 21 illustrates an example of a user information screen;

FIG. 22 is a flowchart illustrating a process of permitting participation of an applicant;

FIG. 23 illustrates an example of a user recommendation screen;

FIG. 24 is a flowchart illustrating an example of a process of registering a recommendation reason;

FIG. 25 illustrates an example of a potential invitee information screen;

FIG. 26 is a flowchart illustrating an example of a process of displaying the potential invitee information screen;

FIG. 27 illustrates an example of a recommendation screen; and

FIG. 28 is a flowchart, illustrating, an example of a process of displaying the recommendation screen.

### DESCRIPTION OF EMBODIMENTS

Several embodiments will be described below with reference to the accompanying drawings, wherein like reference numerals refer to like elements throughout.

### (a) First Embodiment

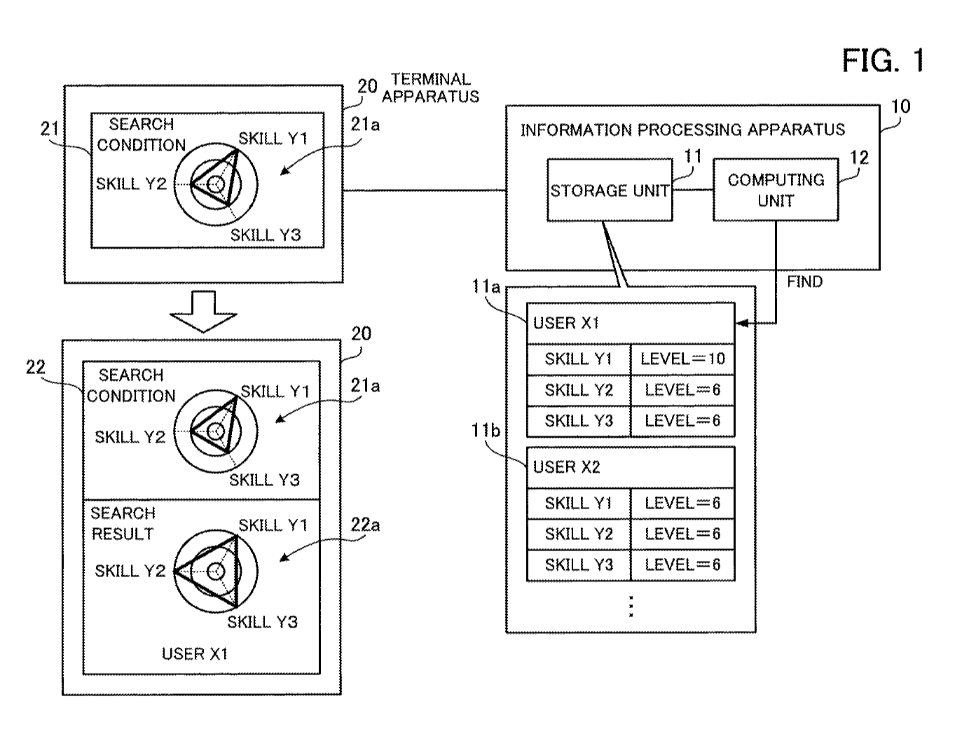

FIG. 1 illustrates an information processing apparatus 10 according to a first embodiment. The information processing apparatus 10 of FIG. 1 is an apparatus that searches for a user (person) having skills that match a search condition from among a plurality of registered users, in response to an input operation from a searcher. In the example of FIG. 1, a terminal apparatus 20 operated by the searcher is connected to the information processing apparatus 10. A display device (not illustrated) is connected to the terminal apparatus 20. The searcher enters a search condition by operating the terminal apparatus 20. Then, the display device displays a screen provided from the information processing apparatus 10 such that the searcher visually recognises the search result.

The information processing apparatus 10 includes a storage unit 11 and a computing unit 12. The storage unit 11 may be a volatile storage device such as a random access memory (RAM) and the like, or may be a non-volatile storage device such as a hard disk drive (HDD), a flash memory, and the like. The computing unit 12 is a processor, for example. The processor may include a central processing unit (CPU), a digital signal processor (DSP), an application specific integrated circuit (ASIC), a field programmable gate array (FPGA), and the like. The computing unit 12 may be a multiprocessor.

The storage unit 11 stores information corresponding to each of a plurality of users and indicating the levels of a plurality of skill items. For example, the storage unit 11 stores user information indicating the levels of a plurality of skill items, for each user. In the example of FIG. 1, user information 11a and user information 11b corresponding to a user X1 and a user X2 are stored in the storage unit 11. The skill item indicates the type of skill of the user. For example, in the field of manufacture and sale of software products, the skill items may include project planning, marketing, designing, program designing, programing, and the like. In the example of FIG. 1, the skill items include skills Y1, Y2, and Y3.

The computing unit 12 receives registration of information corresponding to a user and indicating the levels of the plurality of skill items, and registers the received information in the storage unit 11.

Further, the computing unit 12 receives, as a search condition, an input specifying the levels of the plurality of skill items. Also, the computing unit 12 causes a radar chart 21a including a graph based on the specified levels to be displayed. This allows the searcher to visually recognise the levels of the plurality of skill items specified by the searcher, based on the shape of the graph in the radar chart 21a. In the example of FIG. 1, a display screen 21 including the radar chart 21a is displayed on the terminal apparatus 20.

The computing unit 12 executes a search among a plurality of users registered in the storage unit 11, using the specified levels as the search condition. In this search, the computing unit 12 finds a user having a determined level or higher for as many skill items as possible. Alternatively, the computing unit 12 may find a user having the most similar combination of levels of the respective skill items to a combination of determined levels.

It is assumed here that the user X1 is found by the search. The computing unit 12 causes a radar chart 22a including a graph based on the levels of the plurality of skill items corresponding to the user X1 to be displayed in a manner associated with the user X1. The terminal apparatus 20 displays a display screen 22 including the radar chart 22a indicating the search result, together with the radar chart 21a indicating the search condition. The display screen 22 allows the searcher to intuitively compare the levels of the respective skill items specified as the search condition with the levels of the respective skill items of the user X1 found by the search, based on the shapes of the graphs in the respective radar charts 21a and 22a.

In this manner, the information processing apparatus 10 of the first embodiment allows the searcher to visually recognize the specified search condition as the shape of the graph in the radar chart 21a. Then, when the search is performed, the searcher may check both the radar chart 21a indicating the levels of the respective skill items specified as the search condition and the radar chart 22a indicating the levels of the respective skill items of the found user X1. This allows the searcher to visually compare the entered search condition with the skills of the user X1 and intuitively determine how well the levels of the skills of the user X1 match the search condition. Accordingly, it is possible to increase the efficiency of a search performed by the searcher.

### (b) Second Embodiment

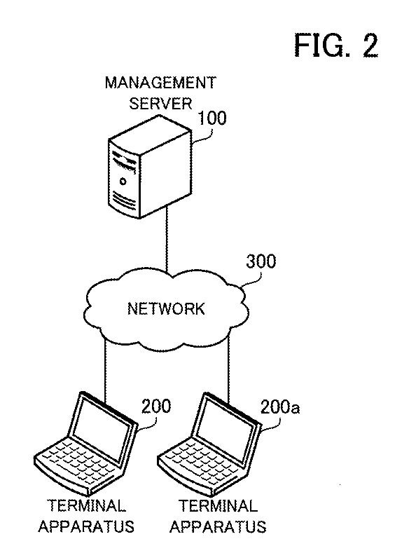

FIG. 2 illustrates an information processing system according to a second embodiment. The information processing system includes a management server 100 and terminal apparatuses 200 and 200a. The information processing system executes various processes related to workshops. For example, the information processing system executes a procedure for organizing a workshop, a procedure for participating in a workshop, a process of inviting to participate in a workshop, and the like. The management server 100 and the terminal apparatuses 200 and 200a are connected to each other via a network 300. The network 300 may be, for example, a local area network (LAN), or a wide area network (WAN) such as the Internet and the like.

The management server 100 is a computer that manages information related to workshops. The management server 100 provides information related to workshops to the terminal apparatuses 200 and 200a, in response to requests from the terminal apparatuses 200 and 200a.

The terminal apparatuses 200 and 200a are computers used by the users registered in the management server 100. Each of the terminal apparatuses 200 and 200a displays information related to workshops transmitted from the management server 100 on its display. The user may perform operations such as registering as a user in the management server 100, organising a workshop, participating in a workshop, inviting to participate in a workshop, searching for other users to be invited, browsing information on other users, and so on, by using the terminal apparatus 200 or the terminal apparatus 200a.

The following describes the hardware of the management server 100.

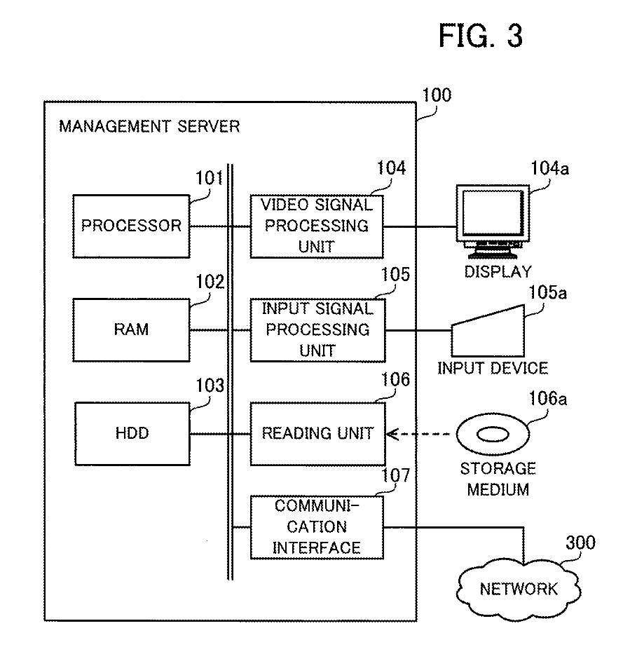

FIG. 3 illustrates an example of hardware of the management server 100. The management server 100 includes a processor 101, a RAM 102, an HDD 103, a video signal processing unit 104, an input signal processing unit 105, a reading unit 106, and a communication interface 107. Each unit is connected to a bus of the management server 100.

The processor 101 controls the overall operation of the management server 100. The processor 101 may be a multiprocessor including a plurality of processing elements. The processor 101 may be, for example, a CPU, a DSP, an ASIC, an FPGA, or the like. Alternatively, the processor 101 may be a combination of two or more elements selected from a CPU, a DSP, an ASIC, an FPGA, and the like.

The RAM 102 is a primary storage device of the management server 100. The RAM 102 temporarily stores at least part of the operating system (OS) program and application programs that are executed by the processor 101. The RAM 102 also stores various types of data used for processing by the processor 101.

The HDD 103 is a secondary storage device of the management server 100. The HDD 103 magnetically writes data to and reads data from an internal magnetic disk. The HDD 103 stores the OS program, application programs, and various types of data. The management server 100 may include other types of secondary storage devices such as a solid state drive (SSD) and the like, and may include a plurality of secondary storage devices.

The video signal processing unit 104 outputs an image to a display 104a connected to the management server 100, in accordance with an instruction from the processor 101. The display 104a may be any of various types of displays such as a liquid crystal display (LCD), an organic electro-luminescence (OEL) display, and the like.

The input signal processing unit 105 obtains an input signal from an input device 105a connected to the management server 100, and outputs the input signal to the processor 101. The input device 105a may be any of various types of input devices such as a pointing device (such as a mouse, a touch panel, and so on), a keyboard, and the like. A plurality of types of input devices may be connected to the management server 100.

The reading unit 106 is a device that reads a program and data stored in a storage medium 106a. Examples of the storage medium 106a include a magnetic disk (such as a flexible disk (FD), an HDD, and so on), an optical disc (such as a compact disc (CD), a digital versatile disc (DVD), and so on), a magneto-optical disc (MO), and the like. Examples of the storage medium 106a may also include a non-volatile semiconductor memory such as a flash memory card. The reading unit 106 reads a program and data from the storage medium 106a, and stores the read program and data in the RAM 102 or the HDD 103, in accordance with an instruction from the processor 101, for example.

The communication interface 107 is an interface that communicates with the terminal apparatuses 200 and 200a via the network 300.

Note that the terminal apparatuses 200 and 200a may also be implemented with the same hardware as that of the management server 100.

The following describes the functions of the management server 100.

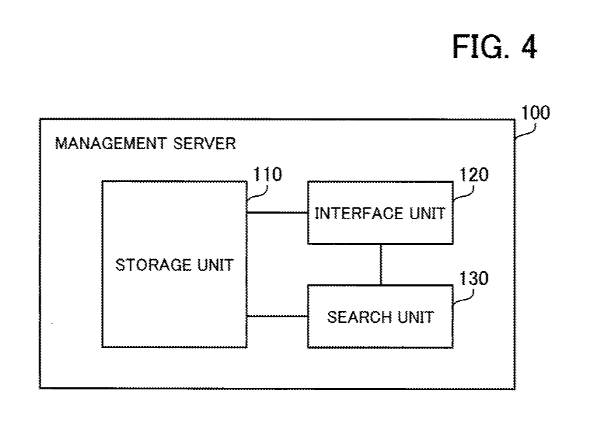

FIG. 4 illustrates an example of functions of the management server 100. The management server 100 includes a storage unit 110, an interface unit 120, and a search unit 130.

The storage unit 110 is implemented as a storage area reserved in the RAM 102 or the HDD 103, for example. The storage unit 110 stores a user table, a workshop object table, a workshop participation table, a workshop invitation table, and a recommendation table.

The user table stores user information. The workshop object table stores information on a workshop. The workshop participation table stores information on participation in a workshop. The workshop invitation table stores information on invitation to a workshop. The recommendation table stores a reason for recommendation.

At least a part of the interface unit 120 and the search unit 130 is implemented by, for example, a predetermined program executed by the processor 101.

The interface unit 120 provides a graphical user interface (GUI) to the terminal apparatuses 200 and 200a. More specifically, the interface unit 120 creates a HyperText Markup Language (HTML) file for displaying the GUI screen. The interface unit 120 transmits the created HTML file to the terminal apparatuses 200 and 200a, and causes the Web browsers of the terminal apparatuses 200 and 200a to display the GUI screen based on the HTML file. The interface unit 120 receives a request for an operation via the GUI screen, and executes the re-quested operation. For example, the interface unit 120 registers information in the storage unit 110, and obtains information from the storage unit 110. Further, in some cases, the interface unit 120 requests the search unit 130 to search for user information. The interface unit 120 transmits the processing result to the source of the request and causes the GUI screen to display the processing results.

The search unit 130 executes a user search when the interface unit 120 receives an instruction for the user search from the terminal apparatus 200 or the terminal apparatus 200a.

The following describes information stored in the storage unit 110 in detail.

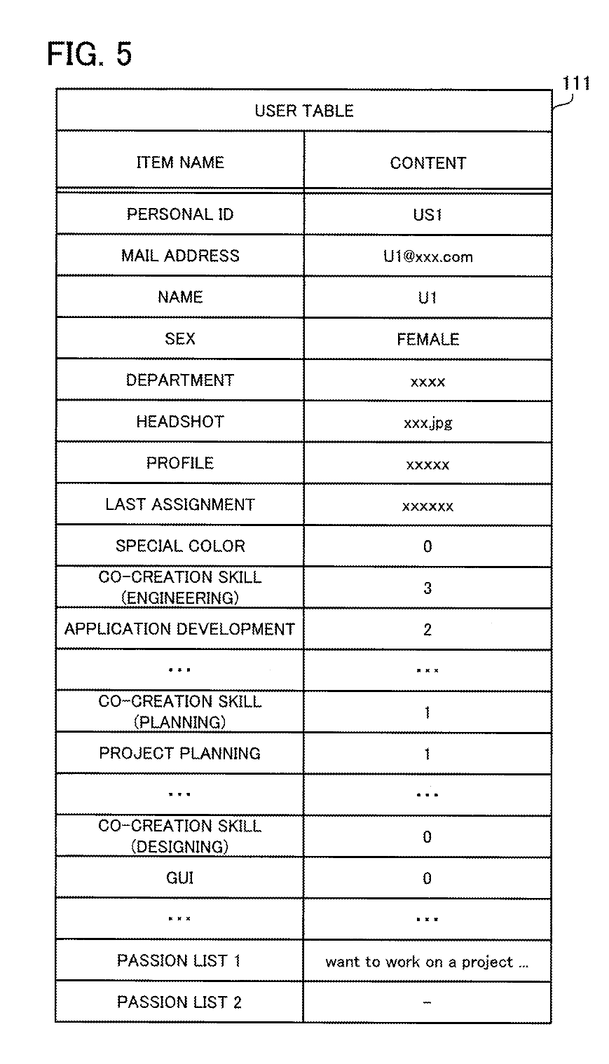

FIG. 5 illustrates an example of a user table 111. The user table 111 is created for each user, and is registered in the storage unit 110.

The user table 111 contains an Item Name field and a Content field. For example, the Item Name includes the following: Personal ID (identifier) for identifying the user; Mail Address of the user; Name of the user; Sex of the user; Department indicating the department to which the user belongs; Headshot indicating the file name of the headshot of the user; Profile of the user; and Last Assignment of the user. The Content stores information corresponding to the Item Name.

The Item Name also includes Special Color. A special color is a color representing the personality of the user and the characteristics based on the personality (for example, a role that the user is good at). The Content of the Special Color stores the number for identifying the color.

The Item Same also includes information on a Skill called “co-creation skill”. The Co-creation Skill is classified into three skill items: Engineering, Planning, and Designing. The user table 111 stores the level for each skill item. Each skill item of the Co-creation Skill is further classified into a plurality of job categories. Although not all the job categories are illustrated in FIG. 5, Engineering is classified into Application Development, Infrastructure Construction, and Hardware Designing; Planning is classified into Project Planning, Marketing, and Intellectual Property; and Designing is classified into GUI, Graphic, Product, and Movie, for example. The user table 111 stores the level of skill for each of these job categories.

The Item Name also includes Passion List 1 and Passion List 2. The Content of the Passion List 1 and Passion List 2 stores information on what the user wishes to do, what the user is interested in, and so on, in a text form, for example.

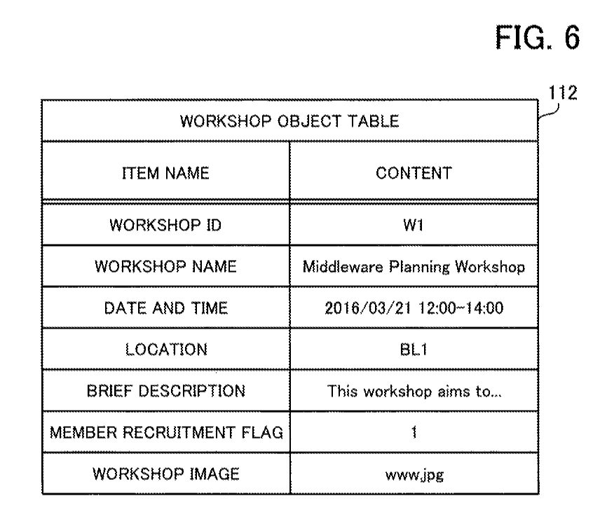

FIG. 6 illustrates an example of a workshop object table 112. The workshop object table 112 is created for each workshop, and is registered in the storage unit 110.

The workshop object table 112 contains an Item Name field and a Content field. The Item Name includes the following: Workshop ID for identifying the workshop; Workshop Name indicating the name of the workshop; Date and Time of the workshop; Location of the workshop; Brief Description briefly describing what will be covered in the workshop; Member Recruitment Flag; and Workshop Image. The Content stores information corresponding to the Item Name. The Member Recruitment Flag indicates whether to recruit users who wish to apply for participation in the workshop. The Content of the Member Recruitment Flag stores the value “1” indicating recruiting applicants or the value “0” indicating not recruiting applicants. The Content of the Workshop Image stores the file name of the image for displaying a screen of the workshop.

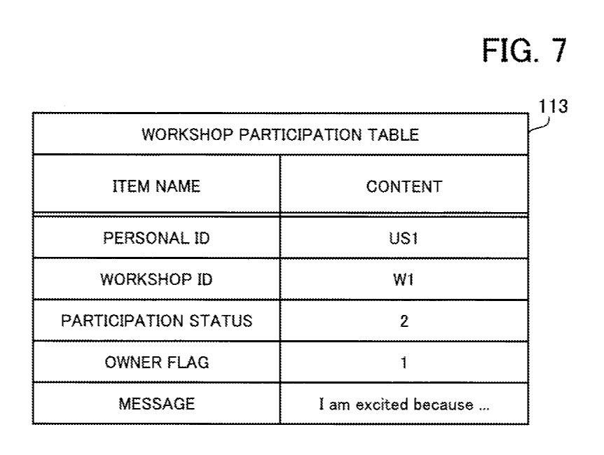

FIG. 7 illustrates an example of a workshop participation table 113. The workshop participation table 113 is created for each user who participates in a workshop, and is registered in the storage unit 110.

The workshop participation table 113 contains an Item Name field and a Content field. The Item Name includes the following: Personal ID for identifying the user; Workshop ID for identifying the workshop; Participation Status; Owner Flag; Message; and so on. The Content stores information corresponding to the Item Name.

The Participation Status indicates whether the user has been offered an invitation to the workshop, the user has applied for participation in the workshop, or the user is going to participate in the workshop. The Content of the Participation Status stores “0” indicating “having been offered an invitation”, “1” indicating “having applied for participation”, or “2” indicating “going to participate”. The Owner Flag indicates whether the user is the owner (organizer) of the workshop. The Content of the Owner Flag stores “1” indicating an owner or “0” indicating a participant. The Content of the Message stores a message to be displayed on a screen of the workshop in a text form.

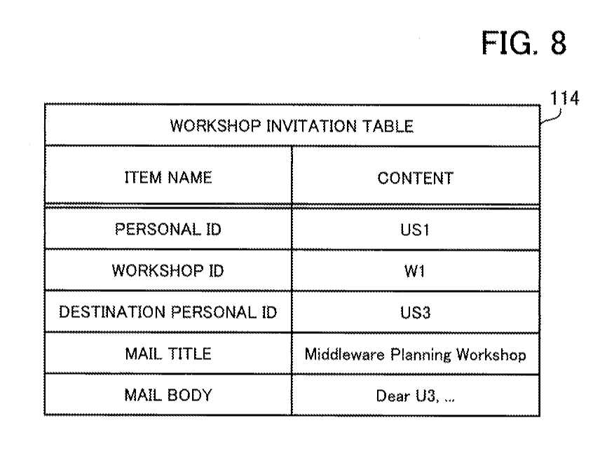

FIG. 8 illustrates an example of a workshop invitation table 114. The workshop invitation table 114 stores the content of an e-mail message created by the owner of the workshop for inviting a user to the workshop, and is registered in the storage unit 110.

The workshop invitation table 114 contains an Item Name field and a Content field. The Item Name includes the following: Personal ID for identifying the source user; Workshop ID for identifying the workshop; Destination Personal ID for identifying the destination user; Mail Title; and Mail Body. The Content stores information corresponding to the Item Name.

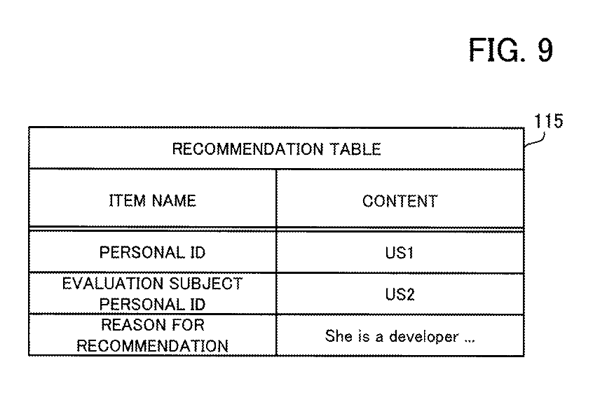

FIG. 9 illustrates an example of a recommendation table 115. The recommendation table 115 is created when a user performs an operation for recommending another user by using a recommend button (described below), and is registered in the storage unit 110.

The recommendation table 115 contains an Item Name field and a Content field. The Item Name includes the following: Personal ID for identifying the user who is recommending another user; Evaluation Subject Personal ID identifying the recommended user (evaluation subject); and Reason for Recommendation. The Content stories information corresponding to the Item Name. The Content of the Reason for Recommendation stores text describing the reason for recommending the evaluation subject.

The following describes a process of registering user information in the management server 100.

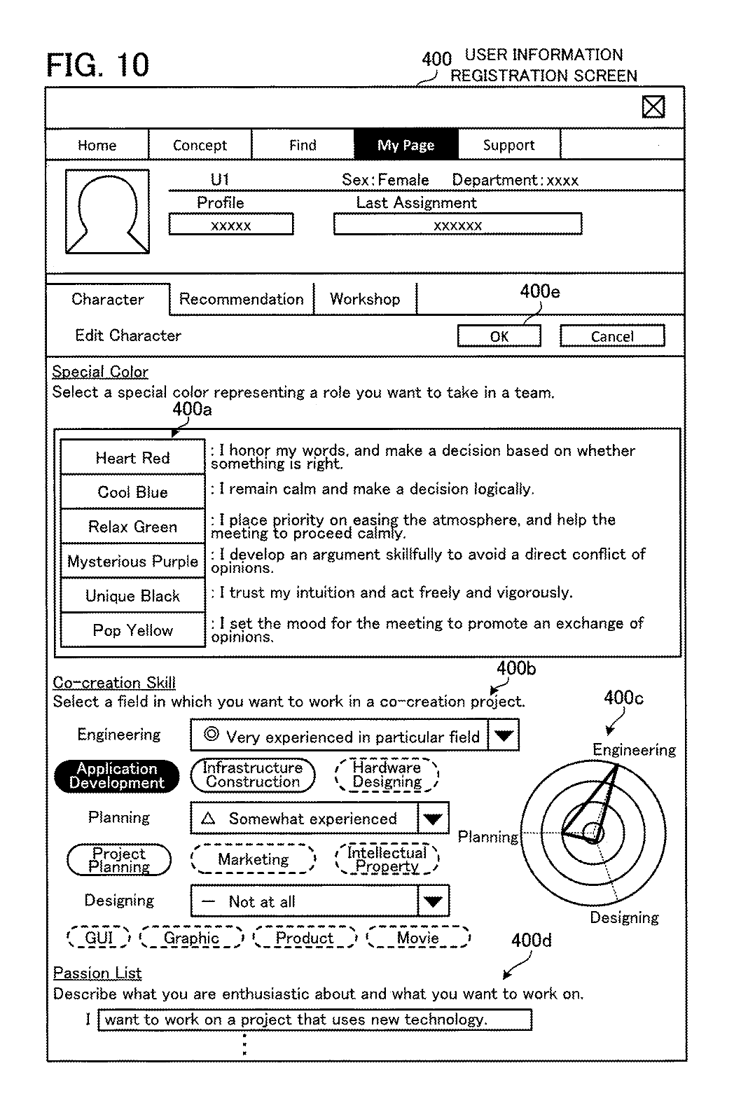

FIG. 10 illustrates an example of a user information registration screen 400. The user information registration screen 400 is a GDI for registering user information. The user information registration screen 400 allows to set the profile, the special color, the co-creation skill, the passion list, and so on.

For example, the user information registration screen 400 displays a button area 400a where buttons for selecting a special color are provided. When any of the buttons in the button area 400a is pressed, a special color is set. As mentioned above, the special color is a color representing the personality of the user, and characteristics based on the personality. For example, “Heart Red” indicates red; “Cool Blue” indicates blue; “Relax Green” indicates green; “Mysterious Purple” indicates Purple; “Unique Black” indicates black; and “Pop Yellow” indicates yellow.

The user information registration screen 400 also displays a setting area 400b for the skill items. In the setting area 400b, one of a plurality of predetermined levels is set for each of the skill items, Engineering, Planning, and Designing. When a level is set for a skill item, the level is reflected to a radar chart 400c. In the radar chart 400c, vertices corresponding to the set levels are plotted on the axes of the respective skill items, and the vertices are connected with straight lines. This allows the user to intuitively recognize the balance of the set levels of the respective skill items.

Further, in the setting area 400b for the skill items, the level of skill may be set for each of the plurality of job categories of each of the skill items. For example, in FIG. 10, Application Development has the highest level, then Infrastructure Construction, and then Hardware Designing.

Further, in a setting area 400d for the passion list, text describing what the user wishes to do and what the user is interested in may be entered. Note that in the setting area 400d, a plurality of pieces of such information may be entered.

After these settings are made, an OK button 400e is pressed. Then, the set user information is transmitted to the management server 100, and its registration is requested.

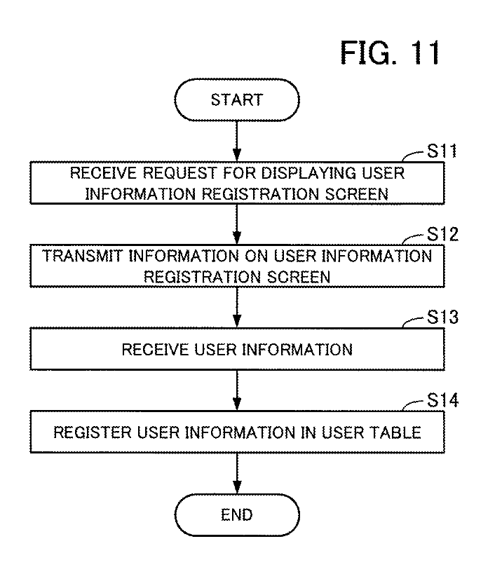

FIG. 11 is a flowchart illustrating an example of a process of registering user information. In the following, the process illustrated in FIG. 11 will be described in order of step number.

(S11) The interface unit 120 receives a request for displaying the user information registration screen 400 from the terminal apparatus 200.

(S12) The interface unit 120 creates an HTML file for displaying the user information registration screen 400 on the terminal apparatus 200. The interface unit 120 transmits the created HTML file to the terminal apparatus 200, and causes the Web browser of the terminal apparatus 200 to display the user information registration screen 400. Thus, the user information registration screen 400 is displayed on the terminal apparatus 200.

Thereafter, the user of the terminal apparatus 200 sets user information on the user information registration screen 400. It is assumed here that the user of the terminal apparatus 200 is a user U1. When the setting of the user information is completed, the user U1 presses the OK button 400e on the user information registration screen 400. When the OK button 400e is pressed, the terminal apparatus 200 transmits the user information to the management server 100 and requests registration.

(S13) The interface unit 120 receives the user information from the terminal apparatus 200.

(S14) The interface unit 120 creates a user-table 111 for the user U1, and registers the received user information in the created user table 111. The interface unit 120 registers, in the storage unit 110, the user table 111 with the informatics registered therein, and then the process ends.

The following describes a process of registering information on a workshop in the management server 100 when the user U1 organizes the workshop.

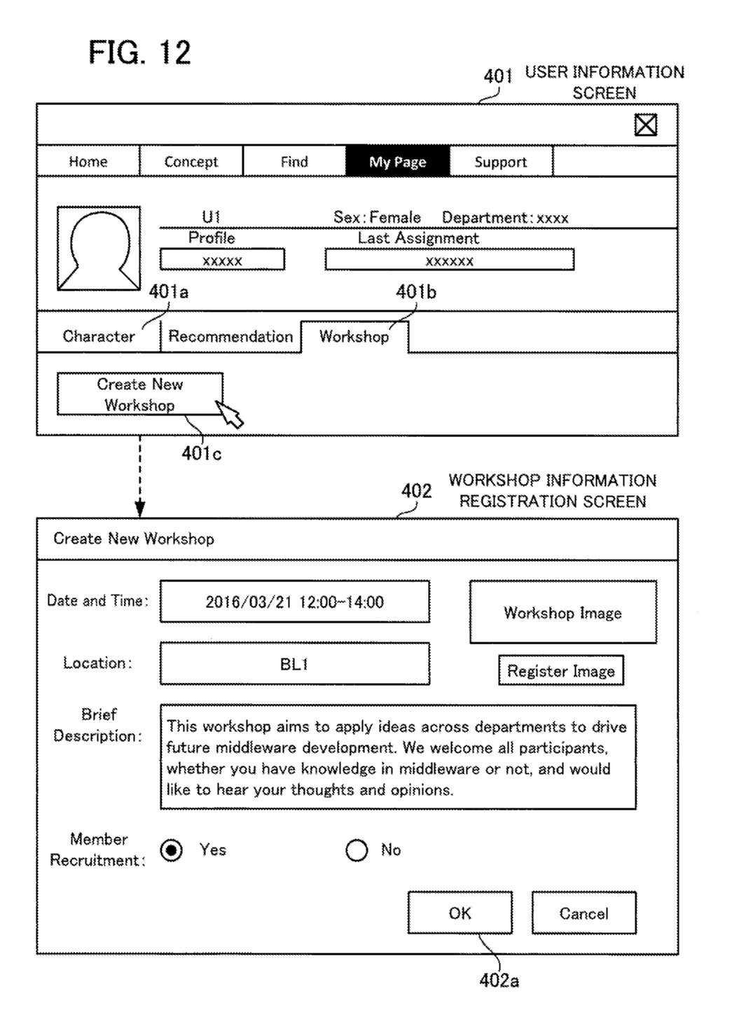

FIG. 12 illustrates an example of a user information screen 401 and a workshop information registration screen 402. The user information screen 401 is a GUI that displays user information. The user information screen 401 displays the details of the registered user information when a Character tab 401a is pressed. Further, as illustrated in FIG. 12, when a Workshop tab 401b is pressed, a create new workshop button 401c for creating a new workshop is displayed.

When the create new workshop button 401c is pressed, the workshop information registration screen 402 is displayed. The workshop information registration screen 402 displays fields for setting workshop information such as the date and time of the workshop, the location of the workshop, and so on. When an OK button 402a is pressed, the set workshop information is transmitted to the management server 100, and its registration is requested.

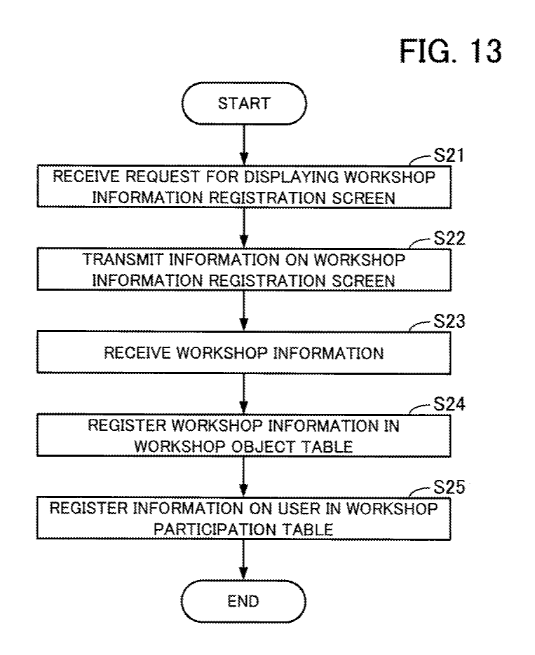

FIG. 13 is a flowchart illustrating an example of a process of registering workshop information. The process of FIG. 13 starts when the user U1 presses the create new workshop button 481c on the user information screen 401. In the following, the process illustrated in FIG. 13 will be described in order of step number.

(S21) The interface unit 120 receives a request for displaying the workshop information registration screen 402 from the terminal apparatus 200.

(S22) The interface unit 120 creates an HTML file for displaying the workshop information registration screen 402 on the terminal apparatus 200. The interface unit 120 transmits the created HTML file to the terminal apparatus 200, and causes the Web browser of the terminal apparatus 200 to display the workshop information registration screen 402. Thus, the workshop information registration screen 402 is displayed on the terminal apparatus 200.

When the workshop information registration screen 402 is displayed, the user U1 sets the date and time of the workshop, the location of the workshop, and the like, on the workshop information registration screen 402. After the settings are made, the user U1 presses the OK button 402a on the workshop information registration screen 402. When the OK button 402a is pressed, the terminal apparatus 200 transmits the workshop information to the management server 100.

(S23) The interface unit 120 receives the workshop information from the terminal apparatus 200.

(S24) The interface unit 120 creates a workshop object table 112, and registers the received workshop information in the created workshop object table 112. The interface unit 120 registers, in the storage unit 110, the workshop object table 112 with the information registered therein.

(S25) The interface unit 120 creates a workshop participation table 113 in which the user ID “U1” of the user U1 is registered in the Personal ID. The interface unit 120 registers the ID of the newly created workshop in the Workshop ID in the created workshop participation table 113, registers “2” indicating “going to participate” in the Participation Status, and registers “1” indicating an owner in the Owner Flag. Further, the interface unit 120 registers, in the Message, the text information entered in the Details of Workshop field on the workshop information registration screen 402. The interface unit 120 registers, in the storage unit 110, the workshop participation table 113 with the above information registered therein.

With the process described above, information indicating that a new workshop is organized by the user U1 as the owner is stored in the management server 100.

The following describes a user search process. For example, the user search process is executed on the management server 100 when the user U1 as the owner of the workshop searches for people whose participation in the workshop is desired.

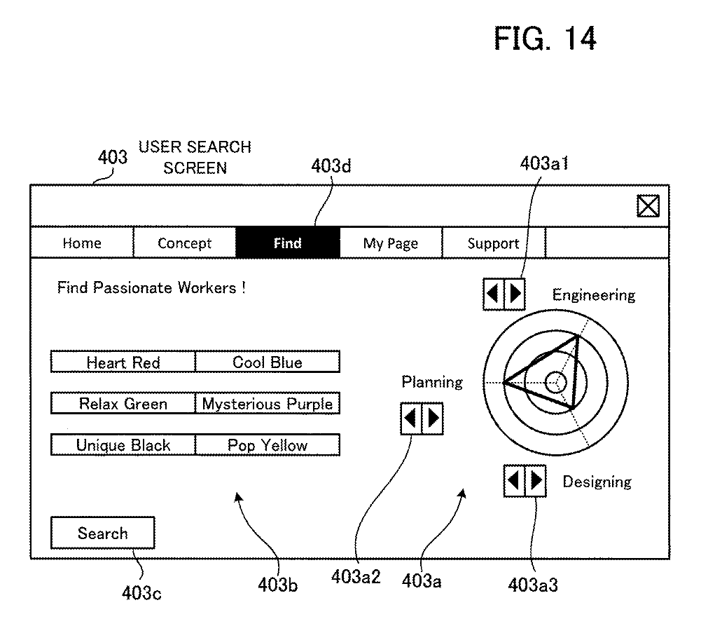

FIG. 14 illustrates an example of a user search screen 403. The user search screen 403 is a GUI for setting a search condition.

The user search screen 403 displays a radar chart 403a for setting the levels of the skill items as the search condition. The axes of the radar chart 403a correspond to the respective skill items, Engineering, Planning, and Designing. The position of a vertex on each axis indicates the level of the corresponding skill item. The user search screen 403 includes setting buttons 403a1 to 403a3 corresponding to the respective axes of the radar chart 403a. The user U1 presses the setting buttons 403a1 to 403a3 to change the positions of the vertices on the corresponding axes, thereby setting the levels of the respective skill items.

In this way, compared to the case where the levels of the respective skill items are set in numeric values by using a keyboard or the like, the user is able to intuitively recognize the levels of the respective skill items that are set as the search condition and their balance from the shape of the radar chart 403a. Further, compared to the case where the user enters numeric values by using a keyboard or the like, it is possible to reduce the workload on the user.

Note that the operation for changing the positions of the vertices on the axes of the radar chart 403a may be performed with, for example, a method that moves the positions of the vertices by dragging a mouse, other than the method described above.

Further, the user may specify a special color as the search condition, in addition to the levels of the items. The user search screen 403 also includes a color specifying area 403b for specifying a special color. The color specifying area 403b includes areas corresponding to respective special colors. When an area is pressed, the corresponding special color is specified. A plurality of special colors may be specified.

The user search screen 403 also includes a search button 403c. The search condition is confirmed when the search button 403c is pressed. That is, the values that are set in the radar chart 403a and the color specifying area 403b at that point of time are transmitted as the search condition to the management server 100. Then, a search based on the search condition is requested.

Although not illustrated, an arbitrary keyword may also be entered in a text form as the search condition. The entered keyword may be used for a search on the passion list registered in each user table 111, for example.

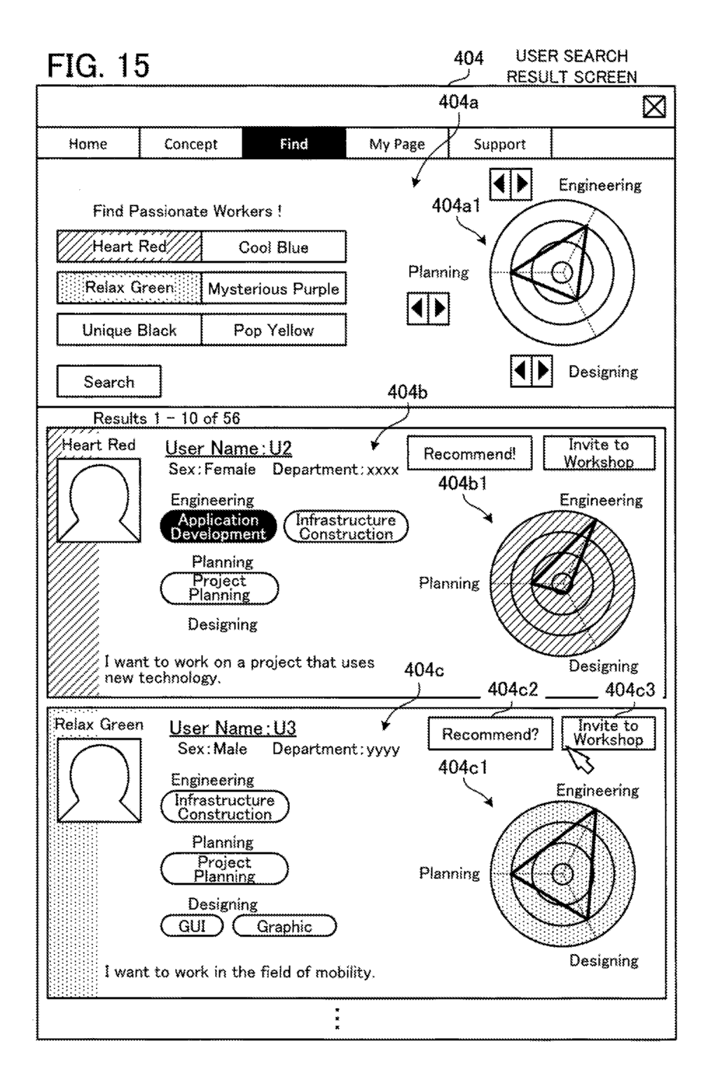

FIG. 15 illustrates an example of a user search result screen 404. The user search result screen 404 is a GUI that displays the search result.

The user search result screen 404 displays information indicating the search condition and the search result. For example, a search condition area 404a for displaying the search condition is displayed at the upper part of the user search result screen 404. Further, under the search condition area 404a, a user area for displaying information on the found users is displayed as the search result. In the example of FIG. 15, users U2 and U3 are found by the search, and user areas 404b and 404c respectively corresponding to the users U2 and U3 are displayed.

The search condition area 404a displays a radar chart 404a1 representing the levels of the respective skill items specified as the search condition. The user area 404b displays a radar chart 404b1 representing the levels of the respective skill items of the found user U2, and the user area 404c displays a radar chart 404c1 representing the levels of the respective skill items of the found user U3. The directions of the axes of the respective skill items and the maximum lengths of the axes match between the radar charts 404a1, 404b1, and 404c1. Accordingly, by comparing the shapes formed by connecting the vertices with straight lines in the respective radar-charts 404a1, 404b1, and 404c1, it is possible to compare the levels of the respective skill items. That is, by comparing these shapes, the user U1 is able to intuitively determine the relationship between the levels of the respective skill items specified as the search condition and the levels of the respective skill items of each user obtained as the search result. For example, the user U1 is able to easily determine whether the levels of the respective skill items of the found user match the search condition.

Further, a special color corresponding to the user is applied to at least a part of each user area. In the example of FIG. 15, special colors are applied to shaded areas. More specifically, special colors are applied to the left ends of the user areas 404b and 404c and the inner areas of the radar charts 404b1 and 404c1. Thus, since the color of at least a part of each user area corresponds to the special color, the user U1 is able to know the personality of the users U2 and U3 displayed as the search result. For example, in the case where a plurality of users having different special colors and similar skills are displayed on the user search result screen 404, the user U1 may select people whose participation in the workshop is desired in view of their personality.

The user area also displays a recommend button and an invite button. For example, the user area 404c displays a recommend button 404c2 and an invite button 404c3. The recommend button is a button that is pressed when the user U1 wishes to recommend the found user to other users. Mote that “Recommend!” is displayed on the recommend button if the user U1 has already recommended the user, and “Recommend?” is displayed when the user U1 has not yet recommended the user. The recommend button may be pressed only in the latter case. The invite button is a button that is pressed when the user U1 wishes to invite the found user to a workshop whose owner is the user U1.

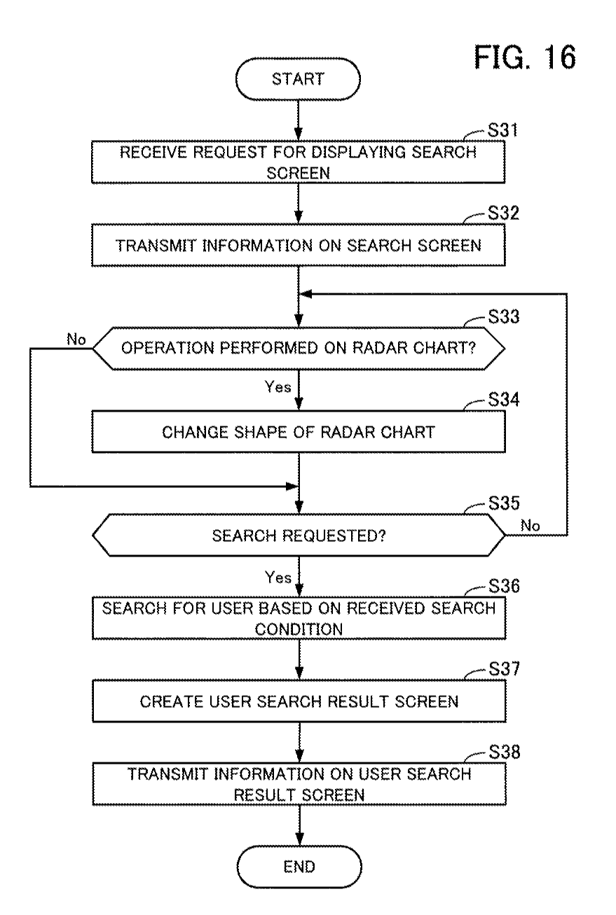

FIG. 16 is a flowchart illustrating an example of a user search process. For example, the process of FIG. 16 starts when the user U1 presses a Find tab 403d (see FIG. 14) on the user search screen 403. In the following, the process illustrated in FIG. 16 will be described in order of step number.

(S31) The interface unit 120 receives a display request of the user search screen 403 from the terminal apparatus 200.

(S32) The interface unit 120 creates an HTML file for displaying the user search screen 403 on the terminal apparatus 200. The interface unit 120 transmits the created HTML file to the terminal apparatus 200, and causes the Web browser of the terminal apparatus 200 to display the user search screen 403. Thus, the user search screen 403 is displayed on the terminal apparatus 200.

(S33) The interface unit 120 determines whether an operation for specifying the levels of the skill items on the radar chart 403a on the user search screen 403 is performed. If an operation for specifying the levels is performed, the proceeds to step S34. If an operation for specifying the levels is not performed, the proceeds to step S35.

(S34) The interface unit 120 changes the shape of the radar chart 403a displayed on the user search screen 403 in accordance with the level specifying operation. More specifically, the interface unit 120 moves the positions of the vertices on the axes of the radar chart 403a, and changes the positions of the straight lines connecting the vertices, in accordance with the level specifying operation.

(S35) The interface unit 120 determines whether execution of a search is requested by pressing the search button 403c. If execution of a search is requested, the process proceeds to step S36. In this case, the interface unit 120 receives a search condition together with a search execution request. The search condition includes the levels of the respective skill items. Further, if a special color has been specified in the color specifying area 403b of the user search screen 403, the search condition also includes the identification information of the special color. On the other hand, if execution of a search is not requested, the process returns to step S33.

Note that the operations in steps S33 to S35 are iteratively executed at predetermined time intervals.

Further, in steps S33 and S34, the shape of the radar chart 403a is changed by an operation executed by the management server 100 in accordance with the level specifying operation. However, in another example, the operation for changing the shape of the radar chart 403a may be executed by the terminal apparatus 200. For example, in step S32, a program is transmitted together with the HTML file of the user search screen 403. Then, the program is executed by the function of the Web browser of the terminal apparatus 200, so that the shape of the radar chart 403a is changed in accordance with the level specifying operation.

(S36) The search unit 130 refers to the user tables 111 to perform a user search, based on the search condition obtained in step S35. For example, the search unit 130 finds users with a greater number of items satisfying the search condition, from among the users registered in the user tables 111. The expression “an item satisfying a search condition” refers to a skill item whose level is equal to or higher than a predetermined level, and the special color being the same as the specified color. Alternatively, the search unit 130 may find users whose skills and special color have higher similarity to those of the search condition, from among the users registered in the user tables 111.

(S37) The interface unit 120 creates a user search result screen 404 containing user information of the users found in step S36. The interface unit 120 creates an HTML file for displaying the user search result screen 404 on the terminal apparatus 200. Note that the HTML file may have information for additionally displaying only the user areas (for example, the user areas 404b and 404c of FIG. 15) for the found users, or may have information for displaying again the search condition area 404a together with these user areas.

(S38) The interface unit 120 transmits the created HTML file to the terminal apparatus 200, and causes the Web browser of the terminal apparatus 200 to display the user search result screen 404. Thus, the user search result screen 404 is displayed on the terminal apparatus 200. Then, the process ends.

The following describes the case where the user U1 invites another user U3 to a workshop.

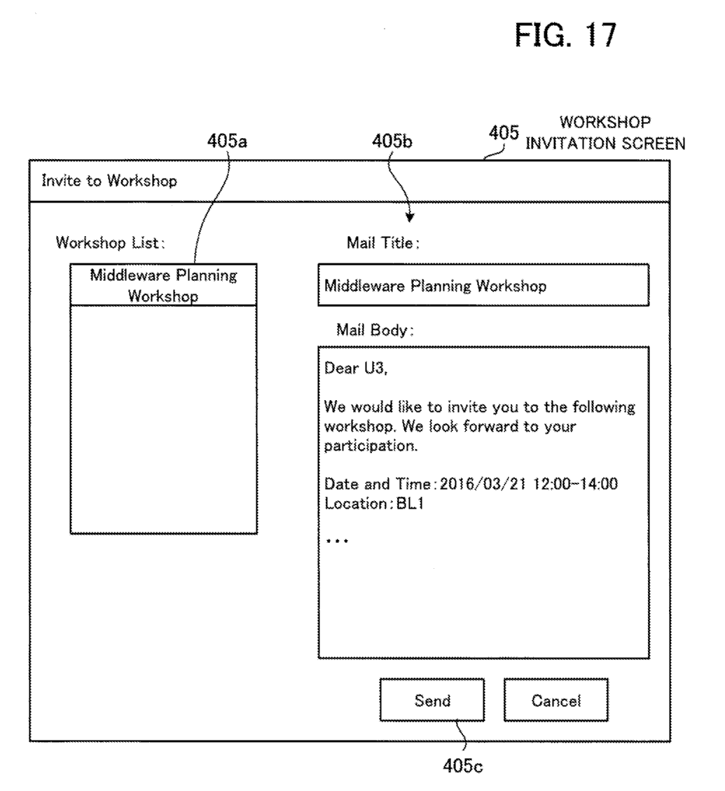

FIG. 17 illustrates an example of a workshop invitation screen 405. The workshop invitation screen 405 is a GUI that displays the content of an invitation to a workshop. For example, the workshop invitation screen 405 is displayed on the terminal apparatus 200 when the invite button 404c3 displayed on the user search result screen 404 is pressed.

The workshop invitation screen 405 displays, in a workshop list display section 405a, a list of workshops whose owner is the user U1. The workshop invitation screen 405 displays a mail entry area 405b for entering e-mail that is transmitted to the user to foe invited. When one of the workshops is selected from the workshop list display section 405a and a send button 405c is pressed, e-mail with the mail title entered in a mail title field and the content entered in a mail body field in the mail entry area 405b is transmitted to the user U3. Thus, the user U3 is informed of that the user 3 is invited to the selected workshop.

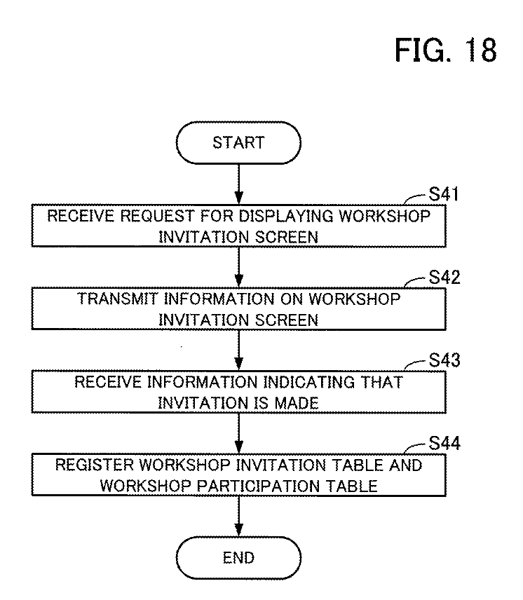

FIG. 18 is a flowchart illustrating an example of a workshop invitation process. The process of FIG. 18 starts when the user U1 presses the invite button displayed on the user search result screen 404. In the following, the process illustrated in FIG. 18 will be described in order of step number.

(S41) The interface unit 120 receives a request for displaying the workshop invitation screen 405 from the terminal apparatus 200. The display request includes information indicating the user to be invited to a workshop. For example, when the user U1 presses the invite button 404c3 for the user U3 displayed on the user search result screen 404, the display request includes information indicating the user U3.

(S42) The interface unit 120 creates an HTML file for displaying the workshop invitation screen 405 on the terminal apparatus 200. The workshop list display section 405a of the workshop invitation screen 405 displays the workshop names, based on the workshop object tables 112 in which the user U1 is registered as the owner. The interface unit 120 transmits the created HTML file to the terminal apparatus 200, and causes the Web browser of the terminal apparatus 200 to display the workshop invitation screen 405. Thus, the workshop invitation screen 405 is displayed on the terminal apparatus 200. Further, the interface unit 120 transmits the workshop invitation table 114 to the terminal apparatus 200.

Thereafter, the user U1 performs an input operation on the workshop invitation screen 405.

(S43) When the send button 405c on the workshop invitation screen 405 is pressed, the interface unit 120 receives information indicating that an invitation is made, from the terminal apparatus 200.

(S44) The interface unit 120 creates a workshop invitation table 114, and registers the ID of the user U1 in the Personal ID, the ID of the workshop in the Workshop ID, and the ID of the user U3 in the Destination Personal ID. The interface unit 120 registers, in the workshop invitation table 114, the mail title and the mail body entered on the workshop invitation screen 405. The interface unit 120 registers the workshop invitation table 114 in the storage unit 110, and executes an operation for transmitting e-mail based on its content.

Further, the interface unit 120 creates a workshop participation table 113 in which the ID of the user U3 is registered in the Personal ID, and registers the workshop participation table 113 in the storage unit 110. In the Participation Status in the workshop participation table 113, the value “0” indicating “having been offered an invitation” is registered. Thereafter, for example, when the user U3 having read the e-mail performs an operation for accepting the invitation to the workshop, the value of the Participation status in the registered workshop participation table 113 is changed to the value “2” indicating “going to participate”.

The following describes the case, where a user U5 of the terminal apparatus 200a applies for participation in a workshop.

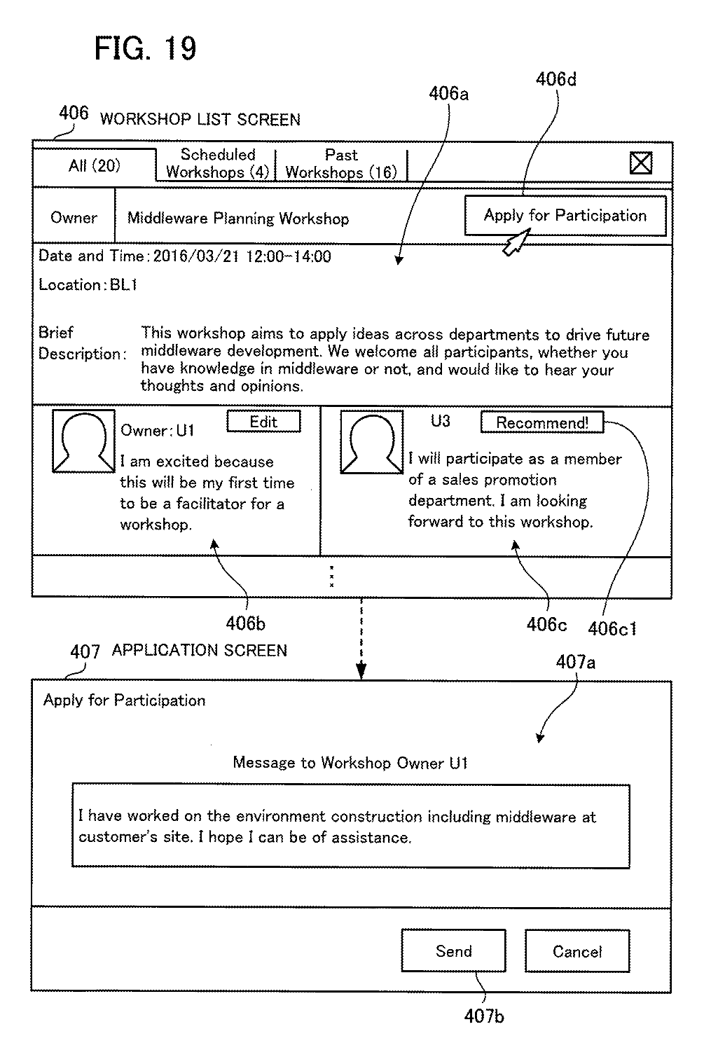

FIG. 19 illustrates an example of a workshop list screen 406 and an application screen 407. The workshop list screen 406 is a GUI that displays a list of workshops and information on the workshops.

The user U5 causes the terminal apparatus 200a to display the workshop list screen 406. The workshop list screen 406 displays a list of pieces of information on the registered workshops. Each area corresponding to one of the workshops displays a workshop information area 406a for displaying the details of the workshop, an owner information area 406b for displaying information on the owner, and a participant information area 406c for displaying information on the participant. The participant information area 406c displays a recommend button 406c1 for recommending the participant. Further, each area corresponding to one of the workshops displays an apply button 406d. The user U5 specifies a workshop in which the user U5 wishes to participate, from a list of workshops displayed on the workshop list screen 406. Then, the user U5 presses the apply button 406d corresponding to the specified workshop.

The application screen 407 is displayed on the terminal apparatus 200a when the apply button 406d is pressed. The application screen 407 is a GUI for setting the content of the application. The application screen 407 displays a message entry section 407a for entering information to be provided to the owner, such as the reason for application and so on, and a send button 407b.

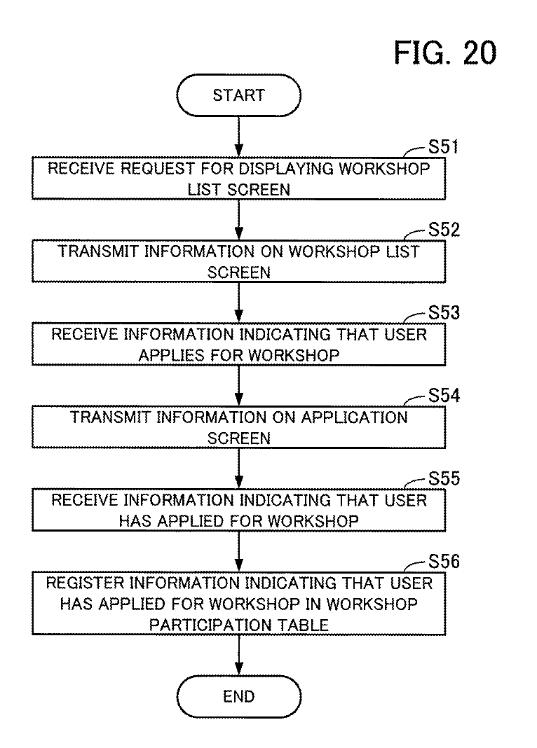

FIG. 20 is a flowchart illustrating an application process. In the following, the process illustrated in FIG. 20 will be described in order of step number.

(S51) The interface unit 120 receives a request for displaying the workshop list screen 406 from the terminal apparatus 200a.

(S52) The interface unit 120 refers to the workshop object table 112 to create the workshop list screen 406. The workshop information area 406a, the owner information area 406b, and the participant information area 406c on the workshop list screen 406 display information based on the workshop object table 112 of the workshop, the user table 111 of the owner, and the workshop participation table 113 of the participant, respectively. The interface unit 120 creates an HTML file for displaying the workshop list screen 406 on the terminal apparatus 200a. The interface unit 120 transmits the created HTML file to the terminal apparatus 200a, and causes the Web browser of the terminal apparatus 200a to display the workshop list screen 406. Thus, the workshop list screen 406 is displayed on the terminal apparatus 200a.

It is assumed that thereafter the user U5 presses the apply button 406d on the workshop list screen 406. When the apply button 406d is pressed, the terminal apparatus 200a transmits, to the management server 100, information indicating that the user 5 applies for the workshop.

(S53) The interface unit 120 receives the information indicating that the user 5 applies for the workshop, from the terminal apparatus 200a. In this step, the ID of the user who performed the operation is reported.

(S54) The interface unit 120 creates an HTML file for displaying the application screen 407 on the terminal apparatus 200a. The interface unit 120 transmits the created HTML file to the terminal apparatus 200a, and causes the Web browser of the terminal apparatus 200a to display the application screen 407. Thus, the application screen 407 is displayed on the terminal apparatus 200a.

When the application screen 407 is displayed, the user U5 enters a message in the message entry section 407a, and presses the send button 407b. When the send button 407b is pressed, the terminal apparatus 200a transmits information indicating that the user U5 has applied for the workshop, to the management server 100.

(S55) The interface unit 120 receives information indicating that the user U5 has applied for the workshop, from the terminal apparatus 200a.

(S56) The interface unit 120 creates a workshop participation table 113 in which the user U5 is registered in the Personal ID, and registers the workshop participation table 113 in the storage unit 110. In the Participation Status in the created workshop participation table 113, the value “1” indicating “having applied for participation” is registered. Then, the process ends.

The following describes the case where the owner of a workshop (the user U1) allows an applicant (the user U5) to participate in the workshop.

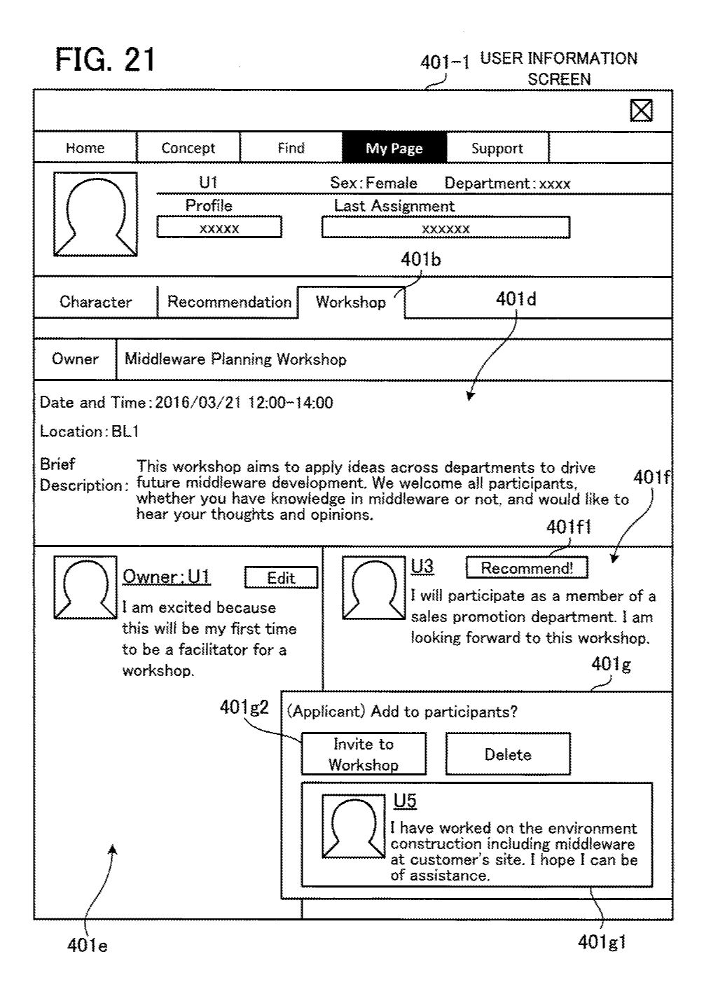

FIG. 21 illustrates an example of a user information screen 401-1. The user information screen 401-1 is a GUI that displays user information. In the case where workshops in which the user U1 participates have been registered, when the user U1 presses a Workshop tab 401b on the user information screen 401-1, a list of workshops is displayed. In FIG. 21, information on a workshop whose owner is the user U1 is displayed. The display area for the information on the workshop displays a workshop information area 401d for displaying the details of the workshop, an owner information area 401e for displaying information on the owner, and a participant information area 401f for displaying information on the participant.

Further, if there is a user who has applied for the workshop, the display area displays an applicant area 401g. In FIG. 21, it is assumed that the user U5 has applied for the workshop. The applicant area 401g displays an applicant information area 401g1 and an invite button 401g2. The applicant information area 401g1 displays the name and photograph of the user 5 who has applied for the workshop, a message from the applicant, and so on. When the user U1 presses the invite button 401g2, the applicant is approved as a participant.

Further, when the user U1 presses the applicant information area 401g1, the user information screen of the user U5 is displayed. The user U1 determines whether to allow the user U5 to participate in the workshop, based on the content displayed on the user information screen.

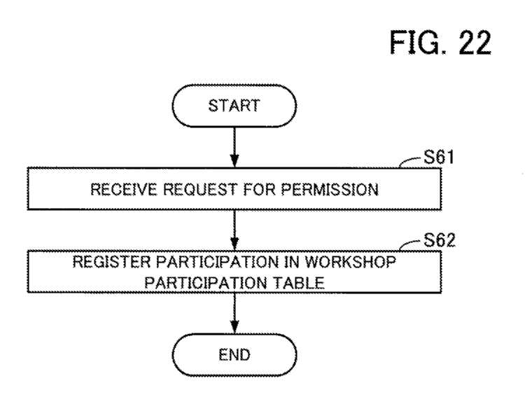

FIG. 22 is a flowchart illustrating a process of permitting participation of an applicant. The process of FIG. 22 starts when the user U1 presses the invite button 401g2 on the user information screen 401-1. In the following, the process illustrated in FIG. 22 will be described in order of step number.

(S61) The interface unit 120 receives a request for permitting participation of the applicant (a user U6) from the terminal apparatus 200.

(S62) The interface unit 120 changes the participation status in the workshop participation table 113 corresponding to the workshop and the user U6 from “1” indicating “having applied for participation” to “2” indicating “going to participate”. Then, the process ends. Note that the interface unit 120 may transmit to the user U6, e-mail indicating that participation is permitted.

The following describes a process of registering the reason why a user recommends another user, in the management server 100.

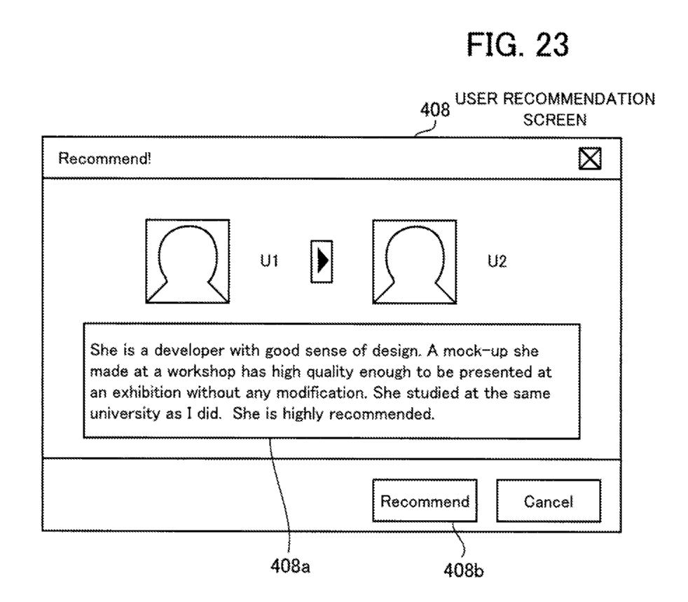

FIG. 23 illustrates an example of a user recommendation screen 408. The user recommendation screen 408 is a GUI for registering the reason for recommendation.

The user recommendation screen 408 is displayed on the terminal apparatus 200 when a recommend button is pressed. For example, the user recommendation screen 408 is displayed on the terminal apparatus 200 when the recommend button in the user area of the user search result screen 404 (for example, the recommend button 404c2 in FIG. 15), the recommend button 406c1 in the participant information area 406c of the workshop list screen 406 (see FIG. 19), or a recommend button 401f1 (see FIG. 21) in the participant information area 401f on the user information screen 401-1 is pressed.

The user recommendation screen 408 displays an entry area 408a for registering the reason for recommendation in a text form. When an execute button 408b on the user recommendation screen 408 is pressed, the management server 100 is requested to register the reason for recommendation.

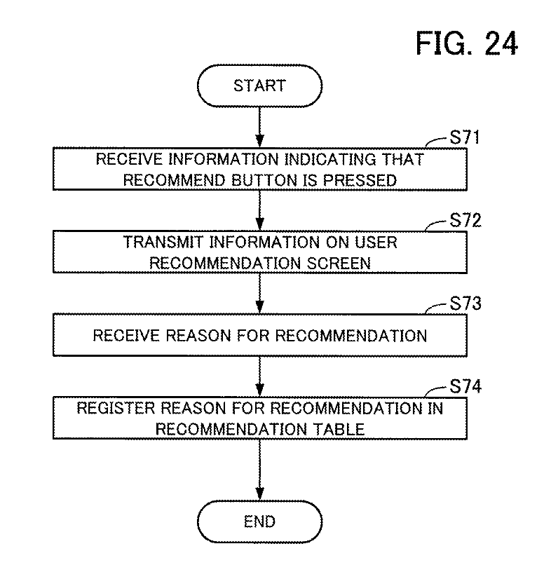

FIG. 24 is a flowchart illustrating an example of a process of registering a recommendation reason. The process of FIG. 24 starts when the user U1 presses a recommend button on any of the screens mentioned above. In the following, the process illustrated in FIG. 24 will be described in order of step number.

(S71) The interface unit 120 receives information indicating that a recommend button is pressed, from the terminal apparatus 200. In this step, the interface unit 120 receives the ID of the user U1 recommending a user, and the ID of the recommended user (the user U2 in this example).

(S72) The interface unit 120 creates an HTML file for displaying the user recommendation screen 408 on the terminal apparatus 200. The interface unit 120 transmits the created HTML file to the terminal apparatus 200, and causes the Web browser of the terminal apparatus 200 to display the user recommendation screen 408. Thus, the user recommendation screen 408 is displayed on the terminal apparatus 200.

When the user recommendation screen 408 is displayed on the terminal apparatus 200, the user U1 enters the reason for recommending the user U2 in the entry area 408a. When the user U1 presses the execute button 408b on the user recommendation screen 408, the terminal apparatus 200 transmits the reason for recommendation to the management server 100.

(S73) The interface unit 120 receives the reason for recommendation from the terminal apparatus 200.

(S74) The Interface unit 120 creates a recommendation table 115, and registers the ID of the user U1 in the personal ID, the ID of the user U2 in the Evaluation Subject Personal ID, and the content entered in the entry area 408a in the Reason for Recommendation. The interface unit 120 registers the created recommendation table 115 in the storage unit 110. Then, the process ends.

The following describes the case where the owner of a workshop (the user U1) wishes to examine a potential invitee to a workshop.

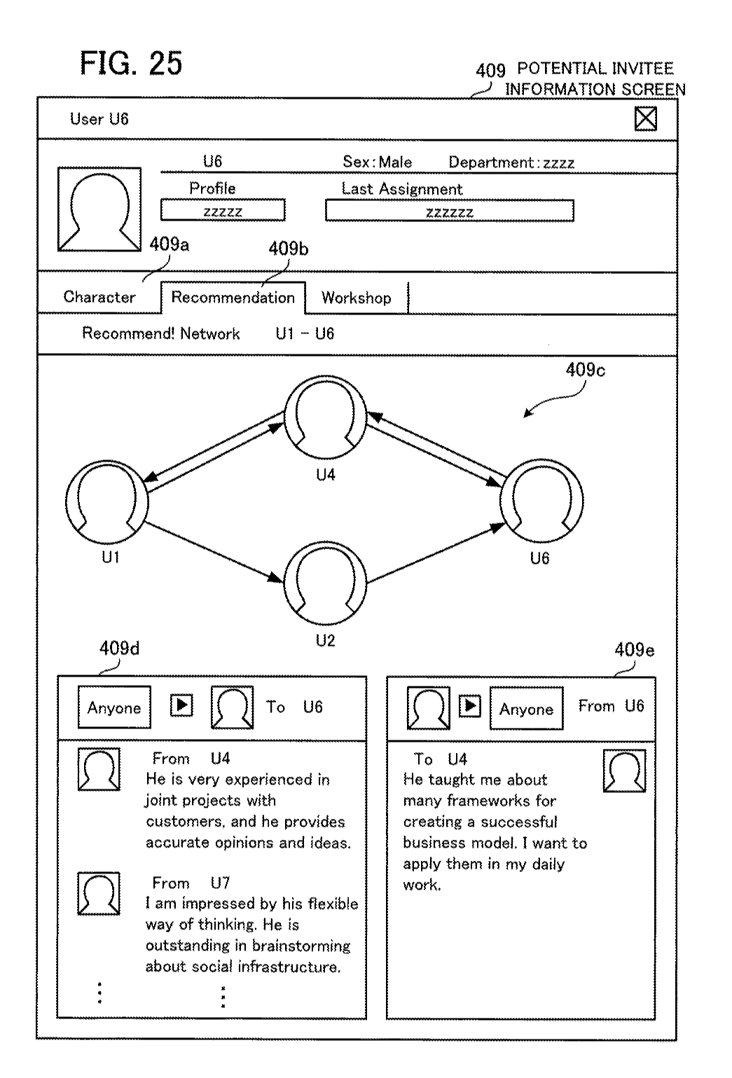

FIG. 25 illustrates an example of a potential invitee information screen 409. The potential invitee information screen 409 is a GUI that displays information on a potential invitee.

For example, when the user U1 searches for potential invitees to the workshop, the user search result screen 404 displays potential invitees to the workshop (see FIG. 15). The user U1 does not personally know one or more of the potential invitees. Thus, in order to determine whether to invite the user that the user U1 does not know personally to the workshop, the user U1 causes the terminal apparatus 200 to display the potential invitee information screen 409 including detailed information on the user. More specifically, when the user U1 presses a headshot in a user area (either one of the user areas 404b and 404c of FIG. 15) displayed on the user search result screen 404, the potential invitee information screen 409 is displayed on the terminal apparatus 200.

The potential invitee information screen 409 may be displayed when viewing the user information on the user who has applied for the workshop. More specifically, the potential invitee information screen 409 is displayed on the terminal apparatus 200, when the user U1 presses the applicant information area 401g1 on the user information screen 401-1 (see FIG. 21).

The potential invitee information screen 409 displays detailed information on a potential invitee. FIG. 25 illustrates the case where the potential invitee information screen 409 displays the detailed information on the user U6 found as a potential invitee. When a Character tab 409a is pressed, the potential invitee information screen 409 displays the detailed information based on the user table 111 of the user U6. Further, when a Recommendation tab 409b is pressed, the potential invitee information screen 409 displays the information based on the recommendation table 115 related to the user U6 as illustrated in FIG. 25. In this case, the potential invitee information screen 409 displays a network diagram 409c, a recommender display section 409d, and a recommended person display section 409e.

In the network diagram 409c, the recommendation relationship between the user U1 as the operator and the user U6 as the potential invitee is represented by arrows, in a range where the user U1 and the user U6 are linked with the recommendation relationship. The directions of the arrows indicate who recommends whom. For example, in the example of FIG. 25, the directions of the arrows indicate that the user U1 recommends the users U2 and U4, and the users U2 and U4 recommend the user U6. Further, the directions of the arrows indicate that the user U6 recommends the user U4, and the user U4 recommends the user U1. In this manner, it is possible to know the recommendation relationship between a recommender and a recommended person from the directions of the arrows.

Since the user U1 and the user U6 are linked, the user U1 may recognize that a recommendation relationship with the user U6 is established via at least a user having a recommendation relationship with the user U1. For example, the user U1 may determine that the user U6 is a more appropriate potential invitee when there are less steps between user U1 and the user U6 in the network diagram 409c.

The network diagram 409c is displayed only when the user U1 as the operator and the user U6 as the potential invitee are linked within a predetermined number of steps. It is difficult to understand the recommendation relationship when there are an excessively large number of steps. Therefore, for example, it is preferable that the network diagram 409c is displayed only when the user U1 and the user U6 are linked within a maximum of three steps (via a maximum, of two other users), for example.

The recommender display section 403d displays users recommending the potential invitee (the user U6), and the reasons for recommendation. The recommender display section 409d displays all the users recommending the user U6 and the reasons for recommendation, regardless of the link of the recommendation relationship from the user U1 to the user U6.

The recommended person display section 409e displays users recommended by the potential invitee (the user U6), and the reasons for recommendation. The recommended person display section 409e displays all the users recommended by the user U6 and the reasons for recommendation, regardless of the link of the recommendation relationship from the user U6 to the user U1.

In this manner, the recommender display section 409d and the recommended person display section 403e display all the users recommending the user U6 and all the users recommended by the user U6, regardless of whether the user U1 and the user U6 are linked. By viewing the names of these users and the reasons for recommendation, the user U1 may find out the relationship between a user that the user U1 does not know personally and the user U6. This allows the user U1 to determine whether the user U6 is an appropriate potential invitee from a view point different front the one based on the network diagram 409c. In particular, since it is possible to view not only the user names but also the reasons for recommendation, the user U1 may learn more precisely about the user U6.

Further, it is possible to view not only the network diagram 409c but also the recommender display section 403d and the recommended person display section 409e. This allows the user U1 to invite appropriate users to the workshop, and increases the efficiency in selecting appropriate users.

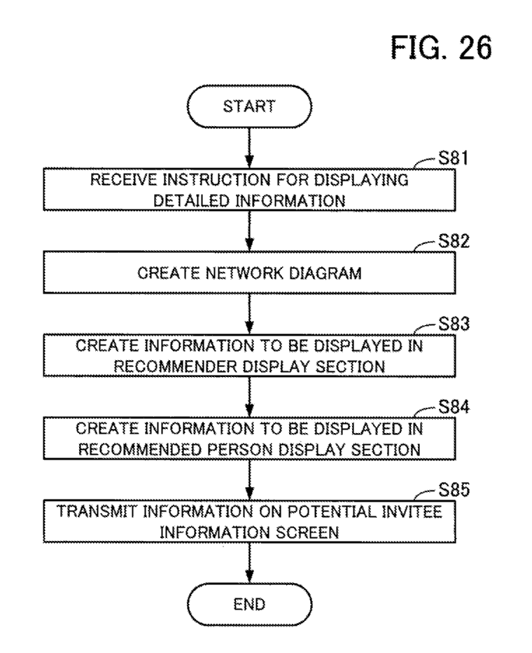

FIG. 26 is a flowchart illustrating an example of a process of displaying the potential invitee information screen 409. The process of FIG. 26 starts when the user U1 presses the Recommendation tab 409b on the potential invitee information screen 409. In the following, the process illustrated in FIG. 26 will be described in order of step number.

(S81) The interface unit 120 receives an instruction for displaying the detailed information on the user (in this example, the user U6) selected by the user U1 from the terminal apparatus 200.

(S82) The interface unit 120 creates a network diagram 409c representing the network between the user U1 and the user U6. More specifically, the interface unit 120 determines the recommendation relationship between the user U1 and the user U6 by tracing the recommendation tables 115 of the recommended users, starting from each of the recommendation table 115 in which the user U1 is set as the recommender (the user registered in the Personal ID) and the recommendation table 115 in which the user U6 is set as the recommender. If the users are linked within a predetermined number of steps, the interface unit 120 creates the network diagram 409c based on the determined recommendation relationship.

(S83) The interface unit 120 creates display information to be displayed in the recommender display section 403d. More specifically, the interface unit 120 specifies all the recommendation tables 115 in which the ID of the user U6 is registered in the Evaluation Subject Personal ID, and creates the display information based on the specified recommendation tables 115.

(S84) The interface unit 120 creates display information to be displayed in the recommended person display section 409e. More specifically, the interface unit 120 specifies all the recommendation tables 115 in which the ID of the user U6 is registered in the Personal ID, and creates the display information based on the specified recommendation tables 115.

(S85) The interface unit 120 creates an HTML file for displaying, on the terminal apparatus 200, the potential invitee information screen 409 including the display information created in steps S82 to S84. The interface unit 120 transmits the created HTML file to the terminal apparatus 200, and causes the Web browser of the terminal apparatus 200 to display the potential invitee information screen 403. Thus, the potential invitee information screen 409 is on the terminal apparatus 200.

The following describes a process of displaying the reason for recommendation.

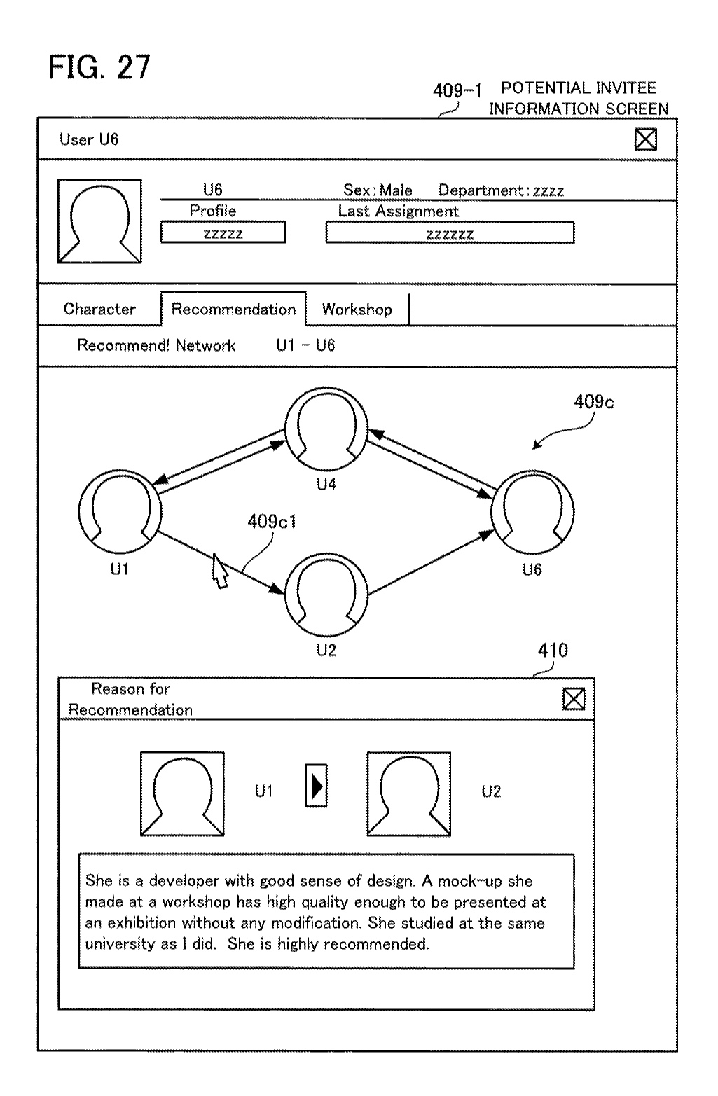

FIG. 27 illustrates an example of a recommendation screen 410. The recommendation screen 410 is a GUI that displays the reason for recommendation. The recommendation screen 410 is displayed on the terminal apparatus 200, when the user U1 presses an arrow in a network diagram 409c displayed on a potential invitee information screen 409-1. For example, the recommendation screen 410 for displaying the reason why the user U1 recommends the user U2 pops up on the potential invitee information screen 409-1, when the user U1 presses an arrow 409c1 indicating the recommendation relationship from the user U1 to the user U2 displayed on the network diagram 403c. In this manner, it is possible to know the reason for recommendation by pressing the arrow.

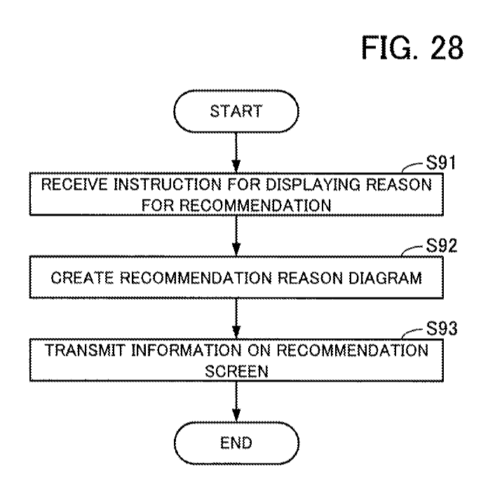

FIG. 28 is a flowchart illustrating an example of a process of displaying the recommendation screen 410. The process of FIG. 28 starts when the user U1 presses an arrow displayed on the network diagram 409c. It is assumed here that the arrow 409c1 representing a recommendation relationship from the user U1 to the user U2 is pressed.

In the following, the process illustrated in FIG. 28 will be described in order of step number.

(S91) The interface unit 120 receives an instruction for displaying the reason for recommendation from the terminal apparatus 200. The display instruction includes the IDs of the recommender (the user U1) and the recommended person (the user U2) having the recommended relationship.

(S92) The interface unit 120 creates a recommendation reason diagram to be displayed on the recommendation screen 410. More specifically, the interface unit 120 specifies a recommendation table 115 in which the ID of the user U1 is registered in the Personal ID and the ID of the user U2 is registered in the Evaluation Subject Personal ID. The interface unit 120 creates a recommendation reason diagram containing the recommendation reason registered in the specified recommendation table 115.

(S93) The interface unit 120 creates an HTML file for displaying, on the terminal apparatus 200, the recommendation screen 410 including the diagram created in step S92. The interface unit 120 transmits the created HTML file to the terminal apparatus 200, and causes the Web browser of the terminal apparatus 200 to display the recommendation screen 410. Thus, the recommendation screen 410 pops up on the potential invitee information screen 409 on the terminal apparatus 200.

Note that the information processing in the first embodiment may be implemented by causing the processor used as the computing unit 12 to execute a program. The information processing of the second embodiment may be implemented by causing the processor 101 to execute a program. Each program may be recorded, in a computer-readable storage medium.

Each program may be stored in a storage medium so as to be distributed, for example. Further, the functions corresponding to the interface unit 120 and the search unit 130 may be implemented by separate programs, and the programs may foe distributed separately. The functions of the interface unit 120 and the search unit 130 may be implemented by separate computers. The computer may store (install) the program stored in the recording medium in its storage device such as the RAM 102 and the HDD 103, and may read and execute the program from the storage device, for example.

According to one aspect, it is possible to intuitively compare a search condition with skills of the user.

All examples and conditional language provided herein are intended for the pedagogical purposes of aiding the reader in understanding the invention and the concepts contributed by the inventor to further the art, and are not to be construed as limitations to such specifically recited examples and conditions, nor does the organisation of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory; and
a processor configured to perform a process including:
receiving registration of information corresponding to a user and indicating levels of a plurality of skill items, and registering the information in the memory,
receiving an input specifying levels of the plurality of skill items, and displaying a radar chart-including a first graph based on the specified levels,
executing a search for a user from among users who are registered, using the specified levels as a search condition, and
displaying a radar chart including a second graph based on levels of the plurality of skill items corresponding to a user found by the search, in a manner associated with the found user.

2. The information processing apparatus according to claim 1, wherein the input specifying the levels of the plurality of skill items is performed by an input operation of changing a shape of the first graph.

3. The information processing apparatus according to claim 1, wherein:
the receiving the registration includes receiving registration of a display type corresponding to an attribute of each user; and
the displaying the radar chart including the second graph includes displaying information on the found user in accordance with the display type corresponding to the found user.

4. The information processing apparatus according to claim 3, wherein:
the display type is color information indicating one of a plurality of colors each representing a personality of a user; and
the displaying the radar chart including the second graph includes applying a color corresponding to the found user to a display area of the information on the found user.

5. The information processing apparatus according to claim 3, wherein:
the receiving the input includes receiving an input of the display type; and
the executing includes executing the search, using the specified levels and the display type as the search condition.

6. The information processing apparatus according to claim 3, wherein the displaying the radar chart including the second graph includes displaying the radar chart including the second graph In accordance with the display type corresponding to the found user.

7. A user search method comprising:
receiving, by a processor, registration of information corresponding to a user and indicating levels of a plurality of skill items;
receiving, by the processor, an input specifying levels of the plurality of skill items, and displaying a radar chart including a first graph based on the specified levels;
executing, by the processor, a search for a user from among users who are registered, using, the specified levels as a search condition; and
displaying, by the processor, a radar, chart including a second graph based on levels of the plurality of skill items corresponding to a user found by the search, in a manner associated with the found user.

8. A non-transitory computer-readable storage medium storing a computer program for user search that causes a computer to perform a process comprising:
receiving registration of information corresponding to a user and indicating levels of a plurality of skill items;
receiving an input specifying levels of the plurality of skill items, and displaying a radar chart including a first graph based on the specified levels;
executing a search for a user from among users who are registered, using the specified levels as a search condition; and
displaying a radar chart including a second graph based on levels of the plurality of skill items corresponding to a user found by the search, in a manner associated with the found user.
